(19) United States
(12) Patent Application Publication
(10) Pub. No.: US 2003/0149841 A1
(43) Pub. Date: Aug. 7, 2003

(54) Management of caches in a data processing apparatus

(76) Inventor: Peter Guy Middleton, Saffron Walden (GB)

Correspondence Address: NIXON & VANDERHYE P.C., 8th Floor, 1100 North Glebe Road, Arlington, VA, 22201, US

(21) Appl. No.: 10/052,488

(22) Filed: Jan. 23, 2002

(51) Int. Cl. G06F 12/00

(52) U.S. Cl. 711/128

(57) ABSTRACT

The present invention relates to the management of caches in a data processing apparatus. An ‘n’-way set-associative cache is disclosed, each way comprises a plurality of cache lines, each of said plurality of cache lines comprising a plurality of data words, each of said plurality of data words having associated therewith a unique address. The unique address includes an address portion. The ‘n’-way set-associative cache comprises a cache memory comprising ‘n’ memory units, each of the ‘n’ memory units having a plurality of entries, respective entries in each of the ‘n’ memory units being associated with the same address portion and being operable to store a data word having that same address portion within its unique address. Also provided is a cache controller operable to determine for a particular way into which of the entries to store the data words of a cache line, each data word being stored at one of the entries within one of the ‘n’ memory units associated with that data word's address portion, each subsequent data word of the cache line being stored in a different memory unit to the previous data word of the cache line so as to maximise the distribution of the data words across the ‘n’ memory units. By maximising the distribution of the cache line data words across the memory units, the number of data words that can be accessed each cycle can be increased. Hence, for any cache line, the number of cycles required to access that cache line is accordingly decreased.

### BACKGROUND OF THE INVENTION

1. Field of the Invention

The present invention relates to the management of caches in a data processing apparatus.

2. Description of the Prior Art

A cache may be arranged to store data and/or instructions so that they are subsequently readily accessible by a processor. Hereafter, the term “data value” will be used to refer to both instructions and data. The cache will store the data value associated with a memory address until it is overwritten by a data value for a new memory address required by the processor. The data value is stored in cache using either physical or virtual memory addresses. Should the data value in the cache have been altered then it is usual to ensure that the altered data value is re-written to the memory, either at the time the data is altered or when the data value in the cache is overwritten.

A number of different configurations have been developed for organising the contents of a cache. One such configuration is the so-called ‘low associative’ cache. In an example 16 Kbyte low associative cache such as the 4-way set associative cache, generally 90, illustrated in FIG. 1, each of the 4 ways 50, 60, 70, 80 contain a number of cache lines 55. A data value (in the following examples, a word) associated with a particular address can be stored in a particular cache line of any of the 4 ways (i.e. each set has 4 cache lines, as illustrated generally by reference numeral 95). Each way stores 4 Kbytes (16 Kbyte cache/4 ways). If each cache line stores eight 32-bit words then there are 32 bytes/cache line (8 words×4 bytes/word) and 128 cache lines in each way ((4 Kbytes/way)/(32 bytes/cache line)). Hence, in this illustrative example, the total number of sets would be equal to 128, i.e. ‘M’ would be 127.

The contents of a full address 47 is also illustrated in FIG. 1. The full address 47 consists of a TAG portion 10, and SET, WORD and BYTE portions 20, 30 and 40, respectively. The SET portion 20 of the full address 47 is used to identify a particular set within the cache 90. The WORD portion 30 identifies a particular word within the cache line 55, identified by the SET portion 20, that is the subject of the access by the processor, whilst the BYTE portion 40 allows a particular byte within the word to be specified, if required.

A word stored in the cache 90 may be read by specifying the full address 47 of the word and by selecting the way which stores the word (the TAG portion 10 is used to determine in which way the word is stored, as will be described below). A logical address 45 (consisting of the SET portion 20 and WORD portion 30) then specifies the logical address of the word within that way. A word stored in the cache 90 may be overwritten to allow a new word for an address requested by the processor to be stored.

Typically, when storing words in the cache 90, a so-called “linefill” technique is used whereby a complete cache line 55 of, for example, 8 words (32 bytes) will be fetched and stored. Depending on the write strategy adopted for the cache 90 (such as write-back), a complete cache line 55 may also need to be evicted prior to the linefill being performed. Hence, the words to be evicted are firstly read from the cache 90 and then the new words are fetched from main memory and written into the cache 90. It will be appreciated that this process may take a number of clock cycles and may have a significant impact on the performance of the processor.

FIG. 2 illustrates one such prior art cache arrangement. The cache 90a comprises 4 Random Access Memory (RAM) chips 50a, 60a, 70a, 80a, each corresponding to one of the ways. The cache 90a has a common address bus ADa which is provided to each RAM chip 50a, 60a, 70a, 80a. The logical address 45 is received over the common address bus and comprises the SET portion 20 and the WORD portion 30 of the full address 47, as illustrated in FIG. 1. Each RAM chip 50a, 60a, 70a, 80a is provided with a common 32-bit write data bus WDa for receiving words to be written therein. Each RAM chip 50a, 60a, 70a, 80a is also provided with a 32-bit read data bus RDa₀₋₃ for receiving words to be read therefrom. Words are accessed using the logical address 45 received over the common address bus ADa.

When reading a word from the cache 90a, as mentioned previously, the word could be stored in any of the 4 ways (and, hence, in any one of the 4 RAM chips 50a, 60a, 70a, 80a). Accordingly, the logical address 45 of the word is provided over the common address bus ADa from the processor (not shown) to each RAM chip 50a, 60a, 70a, 80a. Each RAM chip 50a, 60a, 70a, 80a then outputs the word (a 32-bit word) stored at the location specified by the logical address 45 onto its read data bus RDa₀₋₃. The four read data buses RDa₀₋₃ are received by the multiplexer 15a. A cache controller (not shown) determines (based on the TAG portion 10 of the full address 47) which way the word is stored in and outputs a select way signal to the multiplexer 15a over the select way bus SWYa. The multiplexer 15a then outputs the word from the selected way over the read data bus RDa.

Hence, to read one word from the cache 90a requires each of the RAM chips 50a, 60a, 70a, 80a to output, over a respective read data bus RDa₀₋₃, a word having an address corresponding to the logical address 45 received over the common address bus ADa, and then selecting the required word from the appropriate way. Given that one logical address 45 can be supplied over the common address bus ADa and one corresponding word can be output over the read data bus RDa₀₋₃ in each accessing cycle, reading one word takes one cycle.

Also, to read a cache line of 8 words (such as, for example, the cache line 55a) for eviction prior to a linefill requires reading the 8 words, one at a time, over the read data bus RDa₀₋₃, from one of the RAM chips 50a, 60a, 70a, 80a, which takes 8 cycles.

When writing words to the cache 90a, each RAM chip 50a, 60a, 70a, 80a receives the logical address 45 over the common address bus ADa associated with a word received over common write data bus WDa. The cache controller determines in which way the word is to be stored and outputs a write enable signal over one of the write enable lines WEa₀₋₃. The RAM chip 50a, 60a, 70a, 80a which receives the write enable signal then stores the word received over the write data bus WDa at the logical address 45 specified over the address bus ADa.

Hence, to write 8 words (such as, for example, the cache line 55a) for a linefill requires writing the 8 words, one at a time, over the common write data bus WDa and storing each word in the corresponding logical address 45 of one of the RAM chips 50a, 60a, 70a, 80a, which also takes 8 cycles.

In order to reduce the number of cycles required to read and write a cache line, an alternative arrangement is illustrated in FIG. 3a.

The arrangement of cache 90b increased the number of RAM chips to 8, arranged in 4 pairs. Each pair of RAM chips 50b, 60b, 70b, 80b is associated with a respective way, and each of the pair is associated with either the odd or the even words in that way. The provision of 8 read data buses RDb_{0-3O}, RDb_{0-3E}, two write data buses WDb_{O}, WDb_{E}, and the logical arrangement of the words in the RAM chips allow both an odd and an even word to be accessed in each cycle.

For clarity, the arrangement of only one of the pairs of RAM chips, corresponding to way 0, is illustrated in detail in FIG. 3a. However, it will be appreciated that this arrangement is duplicated as indicated for the remaining ways.

As illustrated in FIG. 3a, RAM chip 50b_{E} stores the even words associated with way 0, whilst RAM chip 50b_{O} stores the odd words associated with way 0.

When reading a word from the cache 90b, each pair of RAM chips 50b, 60b, 70b, 80b receives a logical address 45b over a common address bus ADb. The logical address 45b comprises the SET portion 20, and all bits except the least significant bit (LSB) 46b of the WORD portion 30, of the full address 47 (as illustrated in FIG. 3b). For any particular logical address 45b, each pair of RAM chips 50b, 60b, 70b, 80b outputs the odd and even word corresponding to that logical address 45b over the corresponding read data bus RDb_{0-3E}, RDb_{0-3O} to a respective multiplexer 19b. Each multiplexer 19b receives the LSB 46b of the WORD portion 30 over the line AD′b which is used to select either the read data bus RDb_{0-3E} corresponding to even words or the read data bus RDb_{0-3O} corresponding to odd words. As with the previous example, a multiplexer 15b receives four inputs, each corresponding to an output of the multiplexers 19b. A cache controller (not shown) determines in which way the word is stored and outputs a select way signal to the multiplexer 15b over the select way bus SWYb. The multiplexer 15b then outputs the word from the selected way over the read data bus RDb.

Hence, to read one word from the cache 90b requires each of the RAM chips to output, over a respective read data bus RDb_{0-3E}, RDb_{0-3O}, a word corresponding to the logical address 45b and then selecting the word from the appropriate odd or even way based on the LSB 46b of the WORD portion 30. Given that one logical address 45b can be supplied over the common address bus ADb and one corresponding word can be output over the read data bus RDb_{0-3E}, RDb₀₋_{3O} in each accessing cycle then, as before, reading one word takes one cycle.

In an alternative arrangement, to seek to reduce power consumption, only that RAM chip which stores the requested word is enabled by the cache controller to output the word. In this alternative arrangement it will be appreciated that the multiplexer circuitry 15b, 19b is not required, but additional RAM enable lines would be required.

To read 8 words (such as, for example, the cache line 55b) for eviction prior to a linefill, the multiplexer 17b is utilised. In this situation, the odd and even words corresponding to the logical address 45b received over the address bus ADb are combined to form a 64-bit data value and provided by each pair of RAM chips 50b, 60b, 70b, 80b to the multiplexer 17b. The cache controller determines in which way the two words are stored and outputs a select way signal to the multiplexer 17b over the select way bus SWYb. The multiplexer 17b then outputs the two words from the selected way over the read data bus RDbOE.

Hence, to read 8 words requires reading the 8 words, two at a time, and takes 4 cycles.

When writing words to the cache 90b, each pair of RAM chips 50b, 60b, 70b, 80b receives the logical address 45b over the common address bus ADb corresponding to a word received over the odd write data bus WDb_{O} and a word received over the even write data bus WDb_{E}. The odd write data bus WDb_{O} is provided to each RAM chip associated with odd words (for example 50b_{O}) of each pair of RAM chips, and the even write data bus WDb_{E} is provided to each RAM chip associated with even words (for example 50b_{E}) of each pair of RAM chips. The cache controller determines in which way the word is to be stored and outputs a write enable signal over a write enable line WEb₀₋₇ to the relevant RAM chips. The RAM chips which receive the write enable signal then stores the words received over the write data buses WDb_{O} and WDb_{E} at the logical address 45b received over the common address bus ADb.

Hence, to write 8 words for a linefill requires writing the 8 words, two at a time, over the write data buses WDb_{O} and WDb_{E}, and storing both words in the corresponding logical address 45b of one of the pairs of RAM chips 50b, 60b, 70b, 80b, which takes 4 cycles.

The arrangement in FIG. 3a decreases the time taken to read or write an 8 word cache line from 8 cycles to 4 cycles, whilst retaining a single word read time of one cycle.

However, this increased performance results in an increased hardware overhead. The number of write buses is doubled from one to two and the number of read buses is also doubled from 4 to 8. This results in an increased quantity of multiplexers and requires more routing. This causes the cache to require more area on the substrate and increases the propagation delays between the RAM chips and the processor. This propagation delay can affect cache/processor performance since it generally forms part of the critical path.

In seeking to address some of these shortfalls, a different solution was proposed, as illustrated in FIG. 4a.

The arrangement of cache 90c reduced the number of RAM chips to 4, each RAM chip 50c, 60c, 70c, 80c being arranged logically into halves. The lower logical half of each RAM chip stores even words, whilst the upper logical half of each RAM chip stores odd words. The provision of two write data buses WD_{CH1}, WD_{CH2}, four read data buses RDc₀₋₃ and the logical arrangement of the RAM chips also allows both an odd and an even word to be accessed in each cycle.

As illustrated in FIG. 4a, RAM chip 50c stores the even words associated with way 0 in the lower logical half and odd words associated with way 1 in the upper logical half. RAM chip 60c stores the even words associated with way 1 in the lower logical half and odd words associated with way 0 in the upper logical half. RAM chip 70c stores the even words associated with way 2 in the lower logical half and odd words associated with way 3 in the upper logical half. RAM chip 80c stores the even words associated with way 3 in the lower logical half and odd words associated with way 2 in the upper logical half. The 32-bit write data bus WD_{CH1} is provided to RAM chips 60c and 80c. The 32-bit write data bus WD_{CH2} is provided to RAM chips 50c and 70c. Each RAM chip has a 32-bit read data bus RDc₀₋₃ associated therewith.

A cache controller (not shown) manipulates the address issued by the processor such that it is compatible with the logical arrangement of the RAM chips. For example, the address issued by the processor may take the form of the fill address 47 illustrated in FIG. 1. To map this full address 47 to the logical arrangement of FIG. 4a, the cache controller takes the LSB 46c of the WORD portion 30, shifts all the remaining bits in the SET and WORD portions 20, 30 one position to the right and places the LSB 46c of the WORD portion 20 in the MSB position of the adjacent SET portion 20 and thus produces a logical address 45c, as illustrated in FIG. 4b. Hence, logical addresses 45c which correspond to an odd word will have a logic ‘1’ in the MSB of the SET/WORD portion and such logical addresses 45c will start at a position which is at the logical mid-point of the RAM chip. References hereafter to the logical address 45c of a word in the context of FIG. 4a assumes that the address is the manipulated logical address 45c provided by the cache controller.

When reading a word from the cache 90c, each RAM chip 50c, 60c, 70c, 80c receives from the cache controller an address portion 47c (which corresponds to the SET portion 20 and all the bits of the WORD portion 30 except its LSB as illustrated in FIG. 4b) over the common address bus ADc. The cache controller determines that a single word access is being requested by the processor and the MSB 48c of the logical address 45c (which comprises the LSB 46c) is received over each supplementary address line ADc′, ADc″. These two components which are received over the common ADc and supplementary address line ADc′, ADc″ form the logical address 45c.

Each RAM chip 50c, 60c, 70c, 80c then outputs the word stored at the location specified by the logical address 45c onto its read data bus RDc₀₋₃. The four read data buses RDC₀₋₃ are received by the multiplexer 15c. The cache controller also determines in which way the word is stored and outputs a select way signal to the multiplexer 15c over the select way bus SWYc. The multiplexer 15c then outputs the word from the selected way over the read data bus RDc.

Hence, to read one word from the cache 90c requires each of the RAM chips to output, over a respective read data bus RDc₀₋₃, a word corresponding to the logical address 45c and then selecting the word from the appropriate way. Given that one logical address 45c can be supplied and one corresponding word can be output over the read data bus RDc in each accessing cycle, then as before, reading one word takes one cycle.

However, to read 8 words (such as cache line 55c) for eviction prior to a linefill, the multiplexer 17b is utilised. Each RAM chip 50c, 60c, 70c, 80c receives from the cache controller the address portion 47c over the common address bus ADc. The cache controller determines that a multiple word access is being requested by the processor. Accordingly, supplementary address line ADc′ is provided with the LSB 46c which then becomes the MSB 48c of the logical address 45c provided to the RAM chips 50c and 70c. However, supplementary address line ADc″ is provided with the logical inverse of the signal on address line ADc′.

Hence, the word corresponding to the logical address 45c received by each RAM chip 50c, 60c, 70c, 80c is output over a respective read data bus RDc₀₋₃. The two words output over read data buses RDc₀ and RDc₁ are combined to form a 64-bit word which is provided to one input of the multiplexer 17c. The two words output over read data buses RDc₂ and RDC₃ are combined to form a 64-bit word which is provided to the other input of the multiplexer 17c.

The cache controller determines in which way the words are stored and outputs a select way signal to the multiplexer 17c over the select way bus SWY′c. The multiplexer 17c then outputs the words from the selected way over the read data bus RDc_{OE}.

Hence, to read 8 words requires reading the 8 words, two at a time, over the read data buses RDc_{OE}, and takes 4 cycles.

When writing words to the cache 90c, each RAM chip 50c, 60c, 70c, 80c receives from the cache controller the address portion 47c over the common address bus ADc. The cache controller determines that a write is being requested by the processor and determines in which way the words are to be stored. The cache controller then supplies two words on the appropriate write data buses WDc_{H1-2} and manipulates the address supplied over each supplementary address line ADc′, ADc″ accordingly. The two components received over the common ADc and supplementary address lines ADc′, ADc″ form the logical address 45c associated with the words on the write data buses WDc_{H1-2}. The appropriate two RAM chips receive a write enable signal over the relevant write enable lines WEc₀₋₃ from the cache controller and store the words at the specified address.

Hence, to write 8 words for a linefill requires writing the 8 words, two at a time, over the write data buses WDc_{H1-2}, and storing both words at the corresponding address, which also takes 4 cycles.

The arrangement in FIG. 4a hence decreases the number of RAM chips to 4 whilst maintaining the same access times of four cycles to read or to write a cache line.

It is an object of the present invention to provide an improved technique for managing caches, which enables a further reduction in the access times for reading and writing cache lines.

### SUMMARY OF THE INVENTION

According to a first aspect of the present invention there is provided an ‘n’-way set-associative cache, each way comprising a plurality of cache lines, each of the plurality of cache lines comprising a plurality of data words, each of the plurality of data words having associated therewith a unique address, the unique address including an address portion, the ‘n’-way set-associative cache comprising: a cache memory comprising ‘n’ memory units, each of the ‘n’ memory units having a plurality of entries, respective entries in each of the ‘n’ memory units being associated with the same address portion and being operable to store a data word having that same address portion within its unique address; and a cache controller operable to determine for a particular way into which of the entries to store the data words of a cache line, each data word being stored at one of the entries within one of the ‘n’ memory units associated with that data word's address portion, each subsequent data word of said cache line being stored in a different memory unit to the previous data word of said cache line so as to maximise the distribution of the data words across the ‘n’ memory units.

In accordance with embodiments of the present invention, the cache is arranged to distribute or spread the data words of a cache line across the memory units. Data words preferably may represent both instructions and data, and may comprise any number of bits. By maximising the distribution of the cache line data words across the memory units, the number of data words that can be accessed each cycle is increased. Hence, for any cache line, the number of cycles required to access that cache line is accordingly decreased.

To maximise the distribution, each data word from a cache line is stored in a different memory unit of the cache to the previous data word of the cache line. Thus, each memory unit of the cache can be arranged to store one or more data words of a cache line, thereby maximising or optimising the number of memory units which store the cache line. Each memory unit stores a data word at an entry having an address corresponding to the address portion of the data word to be stored. Respective entries in each memory unit are arranged to have the same address. Hence, any particular data word may be stored in any of the memory units, at the entry associated with the address portion of that data word. However, each of these respective entries is associated with a different way and, hence, each memory unit is arranged to store data words from different ways. By associating entries with both an address portion and a way ensures that for any data word associated with a particular way, there is only one entry into which the data word can be stored.

For example, when a cache line is to be stored in the cache, the cache controller determines into which way to store the cache line. Once a way has been determined, then the cache controller will provide the data words of the cache line to the memory units. Each data word is stored in the entry whose address corresponds to the address portion of the data word. The memory unit which stores that data word is selected based on the way associated with the cache line. Each data word will be stored in a different memory unit to the previous data word. If each memory unit is then arranged to enable one data word to be accessed in each cycle, then one data word of the cache line can be provided by each memory unit in each cycle. Hence, multiple data words of a cache line can be provided in each cycle.

In preferred embodiments, the plurality of entries within each memory unit comprise logically sequential entries having logically sequential address portions, each logically sequential entry being associated with a different way to its preceding logically sequential entry.

Each entry in the memory unit preferably has a logical address associated therewith. These logical addresses relate to the address portion of the data word stored in that entry. The logical address of each entry may range typically from a value of 000H to 3F8H (for a 4K memory unit storing a cache line of eight 32-bit data words) where ‘H’ denotes ‘hexadecimal’ notation. Logically sequential entries are those entries having numerically adjacent logical addresses such as, for example, 000H and 001H or 200H and 1FFH. By associating logically sequential entries within each memory unit with a different way ensures that sequential data words of a cache line are distributed by being stored in different memory units.

In preferred embodiments, the number of data words in a cache line is ‘p’, where ‘p’ is a multiple of ‘n’, and said cache controller is operable to evenly distribute said data words across the ‘n’ memory units.

By ensuring that the number of memory units is a factor of the number of data words in a cache line, it is possible to ensure that each memory unit stores the same number of data words from that cache line, thereby evenly distributing the data words across the memory units. It will be appreciated that ‘p’ and ‘n’ are positive integers. For example, if a cache line has 8 data words then 8 memory units could be provided, each storing 1 data word of the cache line; alternatively 4 memory units could be provided, each storing 2 data words of the cache line; or 2 memory units could be provided, each storing 4 data words of the cache line. Evenly distributing data words simplifies the addressing required to access each data word.

In embodiments, ‘q’ access ports are provided so that up to ‘q’ data words are accessed per clock cycle.

Typically, the cache is synchronous and data words may be accessed each clock cycle. In such a synchronous cache a clock is provided from which timing information can be extracted. The clock cycle is typically the time period between rising edges of a clock signal. Accessing the cache may include a read from or a write to the cache. Access ports are provided to enable data words to be read from or written to the cache. Each access port can access a data word in a clock cycle. By providing ‘q’ access ports, ‘q’ data words can be accessed in each clock cycle, each data word being accessed via one of the access ports in that clock cycle.

In preferred embodiments, ‘q’ equals ‘n’ so that ‘n’ data words are accessed per clock cycle.

Hence, a number of data words equal to the number of memory units may be accessed in or from the cache in each clock cycle. Typically, one data word may be accessed in or from one memory unit in each clock cycle.

In preferred embodiments, the plurality of data words in each cache line is ‘p’, where ‘p’ is greater than ‘n’, and the cache memory has ‘n’ access ports, each access port being operable to access one data word per cycle such that during an access of a cache line of data words, ‘n’ data words are accessed per clock cycle.

Hence, a number of data words (from a single cache line) equal to the number of memory units may be accessed in or from the cache in each clock cycle. If the number of data words in a cache line is a multiple of ‘n’ then a cache line can be accessed in that multiple of clock cycles.

In one embodiment, the ‘n’ access ports are write ports, each write port being operable to write to the cache one data word per cycle such that during the writing of a cache line of data words, ‘n’ data words of the cache line are written per clock cycle.

By writing one data word per clock cycle via each write port, ‘n’ data words of the cache line can be written to the cache in each clock cycle. Again, if the number of data words in a cache line is a multiple of ‘n’ then a cache line can be written to the cache in that multiple of clock cycles.

In one embodiment, the ‘n’ access ports are read ports, each read port being operable to read from the cache one data word per cycle such that during the reading of a cache line of data words, ‘n’ data words of the cache line are read per clock cycle.

By reading one data word per clock cycle via each read port, ‘n’ data words of the cache line can be read from the cache in each clock cycle. Again, if the number of data words in a cache line is a multiple of ‘n’ then a cache line can be read from the cache in that multiple of clock cycles.

In preferred embodiments, the ‘n’-way set-associative cache comprises ‘n’ write ports and ‘n’ read ports, each write or read port being operable to write to/read from the cache one word per cycle such that during the writing or reading of a cache line of data words, ‘n’ data words of the cache line are written/read per clock cycle.

Hence, by providing both read ports and write ports, one data word of the cache line can be written via each write port such that ‘n’ data words can be written to the cache in each clock cycle, or one data word of the cache line can be read via each read port such that ‘n’ data words can be read from the cache in each clock cycle. Again, if the number of data words in a cache line is a multiple of ‘n’ then a cache line can be written to or read from the cache in that multiple of clock cycles.

In an alternative embodiment, the plurality of data words in each cache line is ‘p’, where ‘p’ is less than or equal to ‘n’, and the cache memory has ‘p’ access ports, each access port being operable to access one data word per cycle such that during an access of a cache line of data words, said cache line is accessed in one clock cycle.

Hence, in situations where the number of data words in a cache line is less than or equal to the number of memory units, the whole cache line may be accessed in one clock cycle provided sufficient access ports are provided. For example, if 4 memory units are provided and a cache line has 4 words, then the cache line can be accessed in one clock cycle provided 4 access ports are provided.

In one such embodiment, the ‘p’ access ports are write ports, each write port being operable to write to the cache one data word per cycle such that during the writing of a cache line of data words, the cache line is written in one clock cycle.

In one embodiment, the ‘p’ access ports are read ports, each read port being operable to read from the cache one data word per cycle such that during the reading of a cache line of data words, the cache line is read in one clock cycle.

In some embodiments, the ‘n’-way set-associative cache may comprise ‘p’ write ports and ‘p’ read ports, each write or read port being operable to write to/read from the cache one data word per cycle such that during the writing or reading of a cache line of data words, the cache line is written/read in one clock cycle.

By providing both read ports and write ports, a cache line can be written to or read from the cache in each clock cycle.

In preferred embodiments, the cache controller is operable to cascade the data words across the ‘n’ memory units.

Cascading data words across the memory units assists in distributing each data word of the cache line. Cascading can result in each data word being stored in a position logically offset to the previous data word in a different memory unit. For example, a first data word in a cache line might be stored at an entry having an address of 000H in a first memory unit. The next data word in the cascade may be stored at an entry in a second memory unit having an address offset by 1 entry from the data word stored in the first memory unit, at 001H, and so on. Alternatively, a first data word in the cache line be stored at an entry having an address of 2FFH in a first memory unit. The next data word in the cascade may be stored at an entry in a second memory unit having an address offset by 5 entries from the previous memory unit, at 2FAH, and so on. The memory units can be arranged in a virtual loop such that, when storing a number of data words, once the ‘n^{th}’ memory unit has had an entry stored therein and more data words of the cache line remain to be stored, the cache controller returns to the first memory unit in which it stored a data word to store the next data word of the cache line.

According to a second aspect of the present invention there is provided a method of arranging data words in an ‘n’-way set-associative cache, each way comprising a plurality of cache lines, each of the plurality of cache lines comprising a plurality of data words, each of the plurality of data words having associated therewith a unique address, the unique address including an address portion, the ‘n’-way set-associative cache comprising a cache memory comprising ‘n’ memory units, each of said ‘n’ memory units having a plurality of entries, respective entries in each of said ‘n’ memory units being associated with the same address portion and being operable to store a data word having that same address portion within its unique address, the method of arranging data words comprising the steps of: a) determining a particular way to store the data words of a cache line; b) storing a data word of the cache line at an entry within one of the ‘n’ memory units associated with that data word's address portion, the entry being associated with the way determined at step (a); and c) storing each subsequent data word of the cache line in a different memory unit to the previous data word of the cache line so as to maximise the distribution of the data words across the ‘n’ memory units.

Further, particular and preferred aspects of the present invention are set out in the accompanying claims.

### BRIEF DESCRIPTION OF THE DRAWINGS

The present invention will be described further, by way of example only, with reference to a preferred embodiment thereof as illustrated in the accompanying drawings, in which:

FIG. 1 illustrates an example 4-way set associative cache;

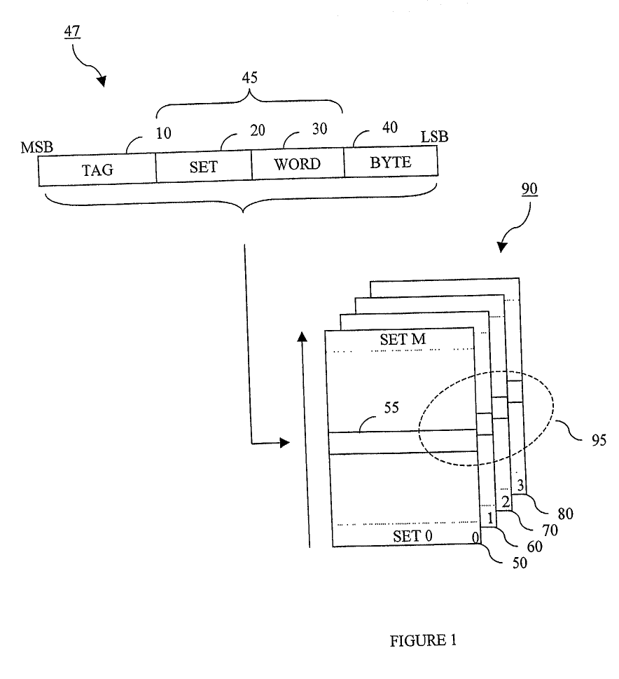

FIG. 2 illustrates a prior art cache arrangement;

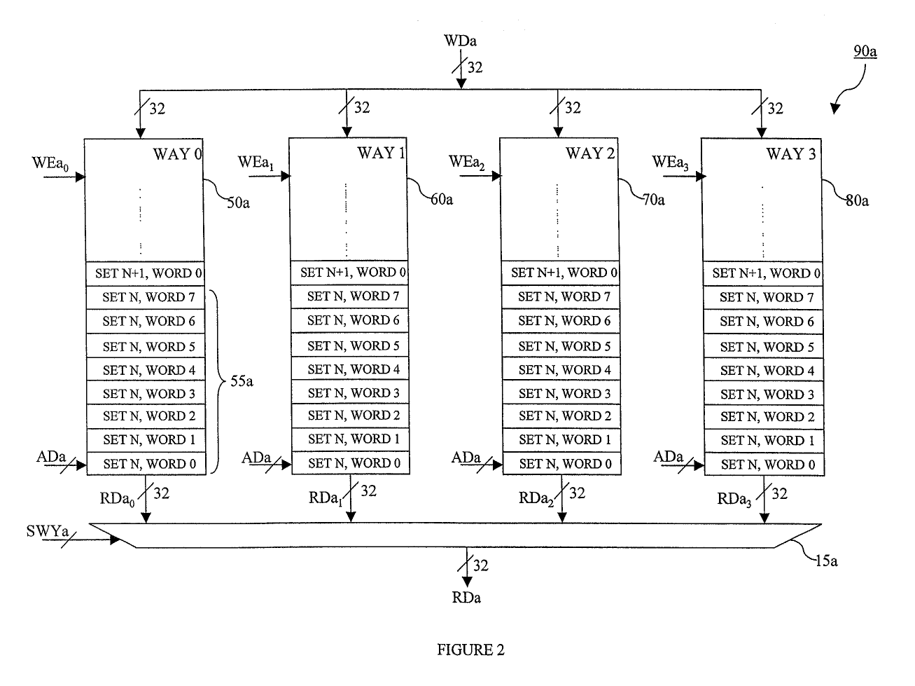

FIG. 3a illustrates another prior art cache arrangement;

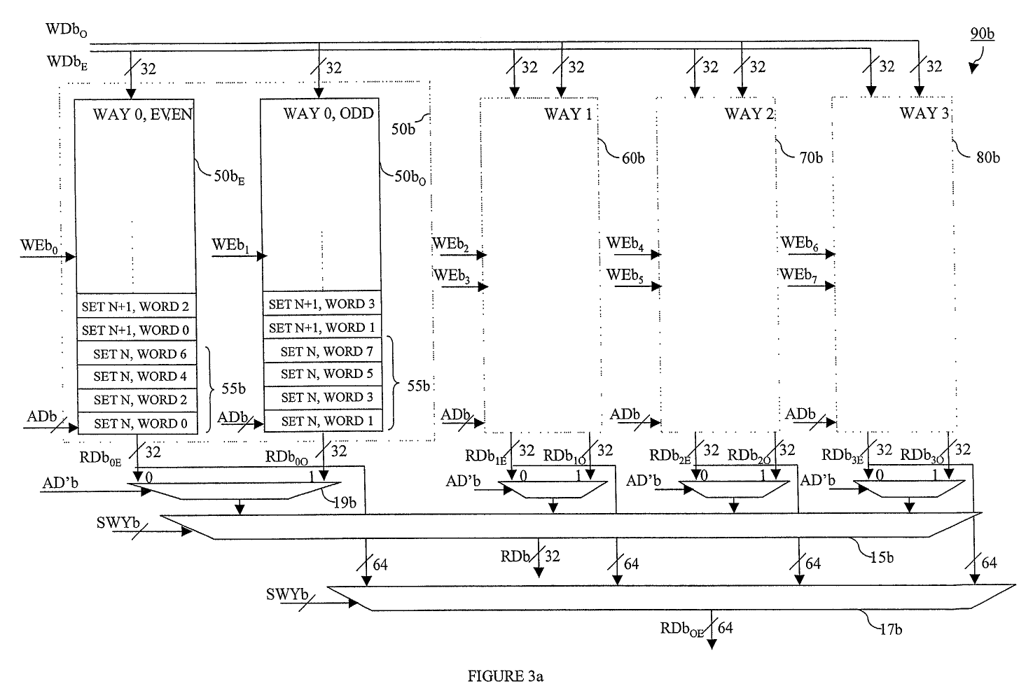

FIG. 3b illustrates an addressing manipulation required to utilise the cache arrangement of FIG. 3a;

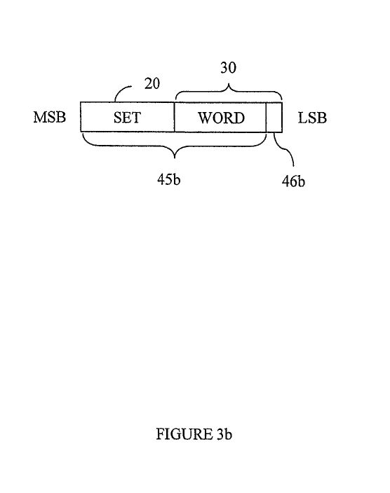

FIG. 4a illustrates yet another prior art cache arrangement;

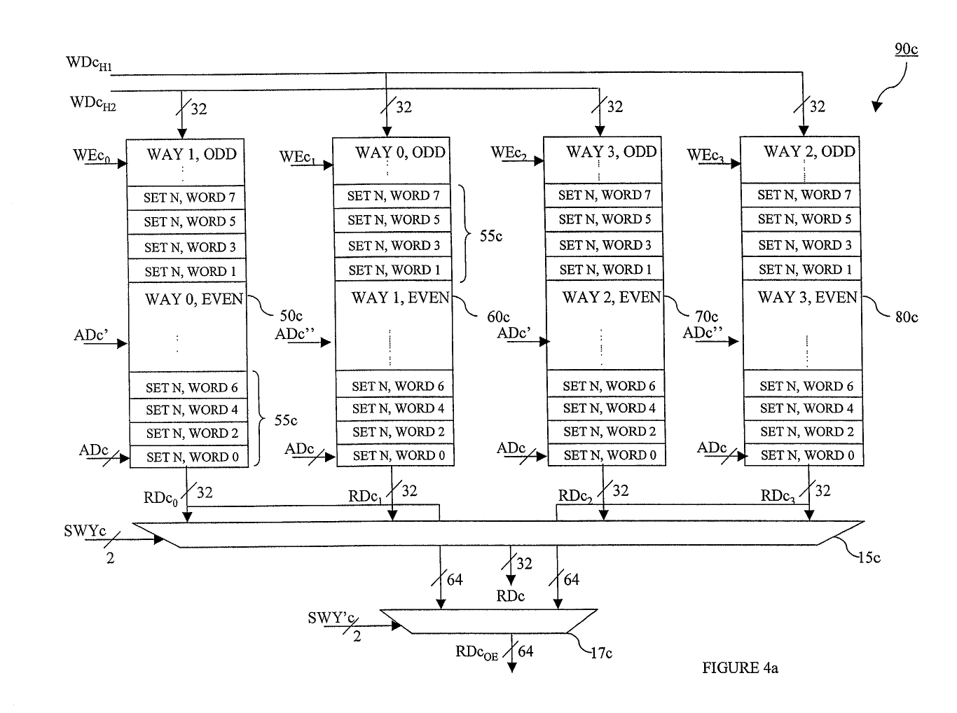

FIG. 4b illustrates an addressing manipulation required to utilise the cache arrangement of FIG. 4a;

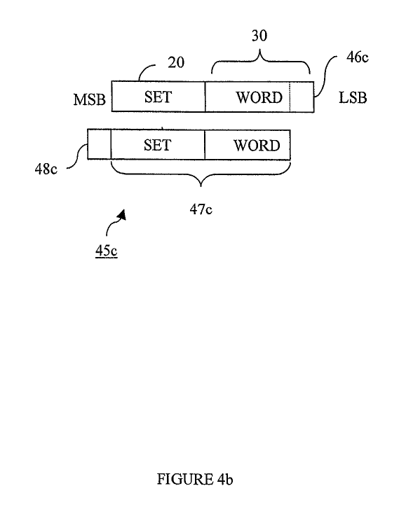

FIG. 5 illustrates a data processing apparatus incorporating a cache according to an embodiment of the present invention;

FIG. 6 provides a schematic view of the cache of FIG. 5;

FIG. 7 illustrates a synchronous memory unit which may be utilised in the cache of FIG. 6;

FIG. 8a illustrates a cache arrangement according to an embodiment of the present invention;

FIG. 8b illustrates a decoding technique for use with the cache of FIG. 8a;

FIG. 8c illustrates a further part of a decoding technique for use with the cache of FIG. 8a;

FIG. 8d illustrates in more detail the multiplexer of FIG. 8a; and

FIG. 9 illustrates an interface buffer arrangement for the cache of FIG. 8a.

### DESCRIPTION OF A PREFERRED EMBODIMENT

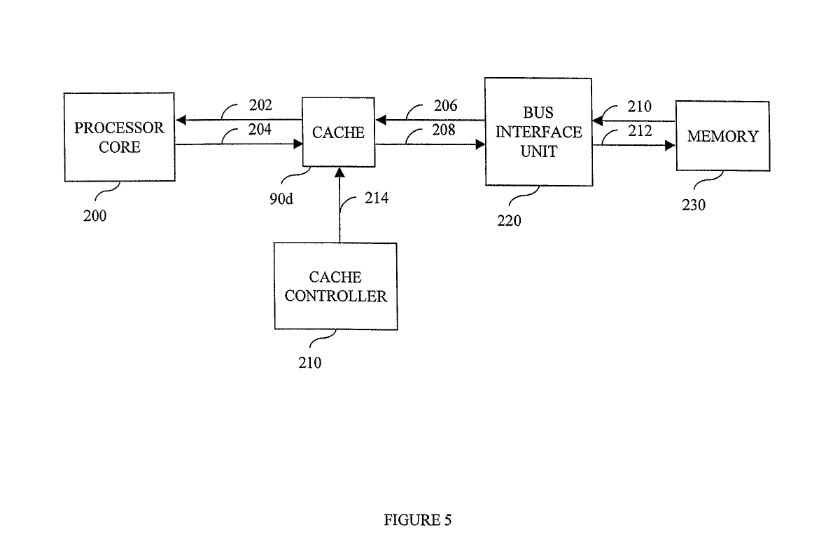

In order to aid understanding an explanation of cache memories and in particular set associative caches, their operation and arrangement, will be described with reference to FIGS. 5 to 7.

A data processing apparatus incorporating a cache 90d will be described with reference to the block diagram of FIG. 5. As shown in FIG. 5, the data processing apparatus has a processor core 200 arranged to process instructions received from memory 230. Data required by the processor core 200 for processing those instructions may also be retrieved from memory 230. The cache 90d is provided for storing data values (which may be data and/or instructions) retrieved from the memory 230 so that they are subsequently readily accessible by the processor core 200. A cache controller 210 controls the storage of data values in the cache 90d and controls the retrieval of the data values from the cache 90d. Whilst it will be appreciated that a data value may be of any appropriate size, for the purposes of the preferred embodiment description it will be assumed that each data value is one word (32 bits) in size.

When the processor core 200 requires to read a data value, it initiates a request by placing an address for the data value on a processor address bus (not shown), and a control signal on a control bus (not shown). The control bus includes information such as whether the request specifies an instruction or data, read or write, word, half word or byte, etc. The processor address on the address bus is received by the cache 90d and compared with the addresses in the cache 90d to determine whether the required data value is stored in the cache 90d. If the data value is stored in the cache 90d, then the cache 90d outputs the data value onto the processor data bus 202. If the data value corresponding to the address is not within the cache 90d, then the bus interface unit (BIU) 220 is used to retrieve the data value from memory 230.

The BIU 220 will examine the processor control signal on the control bus to determine whether the request issued by the processor core 200 is a read or write instruction. For a read request, should there be a cache miss, the BIU 220 will initiate a read from memory 230, passing the address to the memory on an external address bus (not shown). A control signal is placed on an external control bus (not shown). The memory 230 will determine from the control signal on the external control bus that a memory read is required and will then output on the data bus 210 the data value at the address indicated on the external address bus. The BIU 220 will then pass the data from external data bus 210 over bus 206 to the processor data bus 202 via the cache, so that it can be stored in the cache 90d and read by the processor core 200. Subsequently, that data value can readily be accessed directly from the cache 90d by the processor core 200 via the processor data bus 202.

The cache 90d typically comprises a number of cache lines, each cache line being arranged to store a plurality of data values. When a data value is retrieved from memory 230 for storage in the cache 90d, then in preferred embodiments a number of data values are retrieved from memory in order to fill an entire cache line, this technique often being referred to as a “linefill”. In preferred embodiments, such a linefill results from the processor core 200 requesting a cacheable data value that is not currently stored in the cache 90d, thus invoking the memory read process described earlier. It will be appreciated that in addition to performing a linefill on a read miss, a linefill can also be performed on a write miss, depending on the allocation policy adopted.

A linefill requires the memory 230 to be accessed via the external buses. This process is relatively slow, and is governed by the memory speed and the external bus speed.

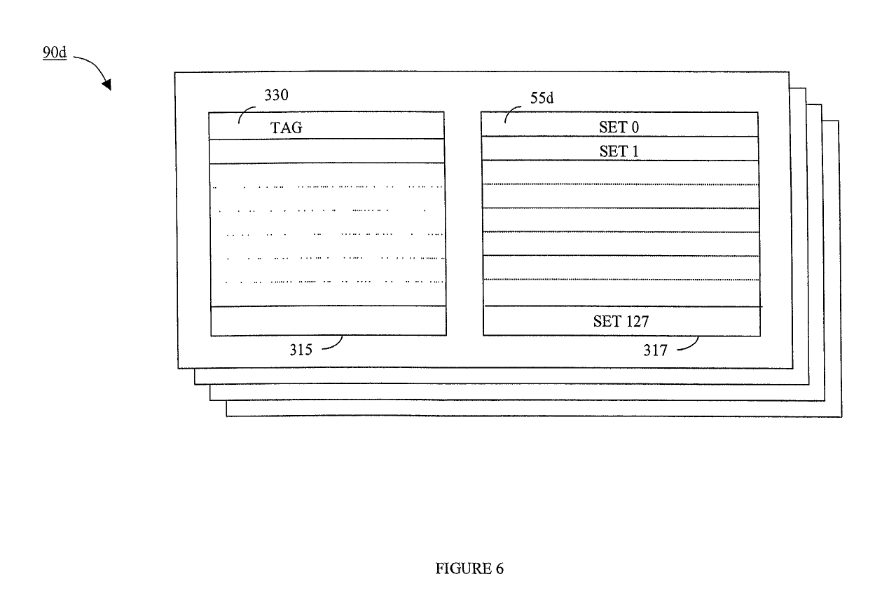

FIG. 6 provides a schematic view of way 0 of cache 90d. Each entry 330 in a TAG memory 315 is associated with a corresponding cache line 55d in a data memory 317, each cache line containing a plurality of data values. The cache controller determines whether the TAG portion 10 of the full address 47 issued by the processor 200 matches the TAG in one of the TAG entries 330 of the TAG memory 315 of any of the ways. If a match is found then the data value in the corresponding cache line 55d for that way identified by the SET and WORD portions 20, 30 of the full address 47 will be output from the cache 90d, assuming the cache line is valid (the marking of the cache lines as valid is discussed below).

In addition to the TAG stored in a TAG entry 330 for each cache line 55d, a number of status bits (not shown) are preferably provided for each cache line. Preferably, these status bits are also provided within the TAG memory 315. Hence, associated with each cache line, are a valid bit and a dirty bit. As will be appreciated by those skilled in the art, the valid bit is used to indicate whether a data value stored in the corresponding cache line is still considered valid or not. Hence, setting the valid bit will indicate that the corresponding data values are valid, whilst resetting the valid bit will indicate that at least one of the data values is no longer valid.

Further, as will be appreciated by those skilled in the art, the dirty bit is used to indicate whether any of the data values stored in the corresponding cache line are more up-to-date than the data value stored in memory 230. The value of the dirty bit 350 is relevant for write back regions of memory 230, where a data value output by the processor core 200 and stored in the cache 90d is not immediately also passed to the memory 230 for storage, but rather the decision as to whether that data value should be passed to memory 230 is taken at the time that the particular cache line is overwritten, or “evicted”, from the cache 90d. Accordingly, a dirty bit which is not set will indicate that the data values stored in the corresponding cache line correspond to the data values stored in memory 230, whilst a dirty bit being set will indicate that at least one of the data values stored in the corresponding cache line has been updated, and the updated data value has not yet been passed to the memory 230.

In a typical prior art cache, when the data values in a cache line are overwritten in the cache, they will be output to memory 230 for storage if the valid and dirty bits indicate that the data values are both valid and dirty. If the data values are not valid, or are not dirty, then the data values can be overwritten without the requirement to pass the data values back to memory 230.

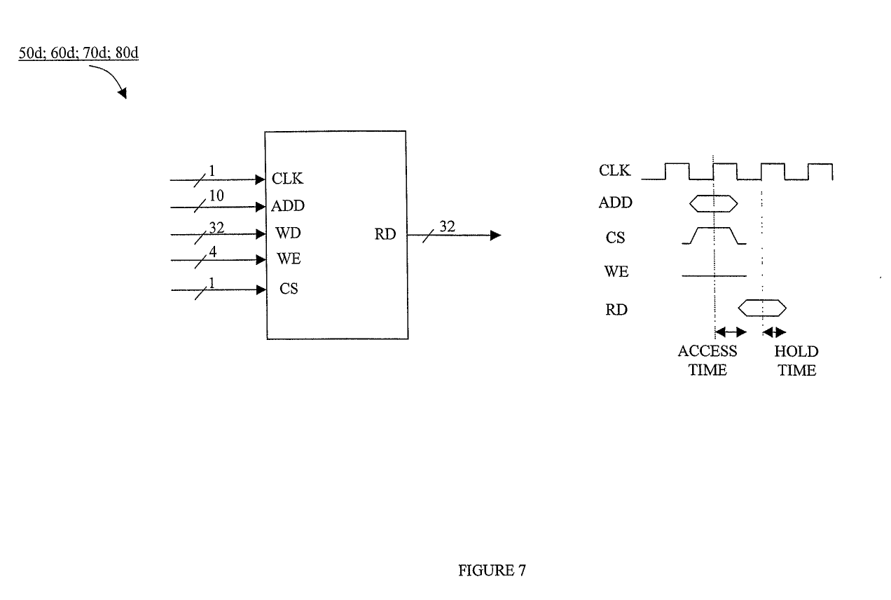

FIG. 7 illustrates a synchronous memory unit which may be utilised in the cache of FIG. 6.

The synchronous memory unit or RAM chip may be coupled to a read bus RD, a write bus WD, an address bus AD, a clock line CLK, a write enable line WE and a chip select line CS.

A clock signal is received over the clock line CLK provides timing information to the memory unit. The memory unit is arranged to perform actions on the rising edge of the clock signal.

An address can be received over the address bus ADD and corresponds to an address of a data value, in this example a data word, to be written into or read from the memory unit over the write bus WD or read bus RD respectively.

The operation of the memory unit, such as an example 16 Kbyte cache, when reading a data word is illustrated in FIG. 7. The address of a data word to be read is provided on the 10-bit address bus ADD, and the chip select signal is enabled by changing the logic level of the chip select line CS from a logical ‘0’to a logical ‘1’. These signals are provided at a particular time before the rising edge of the clock signal to allow the signals to propagate and settle. During the next clock cycle, the memory unit begins to access the data word stored at the address specified such that, after a short access time, the data word is provided on the 32-bit read bus RD for sampling off the next rising edge of the clock signal (assuming a cache hit).

The operation of the memory unit when writing a data word (not illustrated) is similar. The address of a data word to be written is provided on the 10-bit address bus ADD, the data word to be written is provided on the 32-bit write bus WD and the write enable signals are enabled by changing the logic level of the appropriate write enable lines WE from a logical ‘0’ to a logical ‘1’ to indicate a word write. These signals are provided at a particular time before the rising edge of the clock signal to allow the signals to propagate and settle. On the rising edge of the clock signal, the data word provided on the write bus WD is written into the memory unit at the address specified on the address bus ADD.

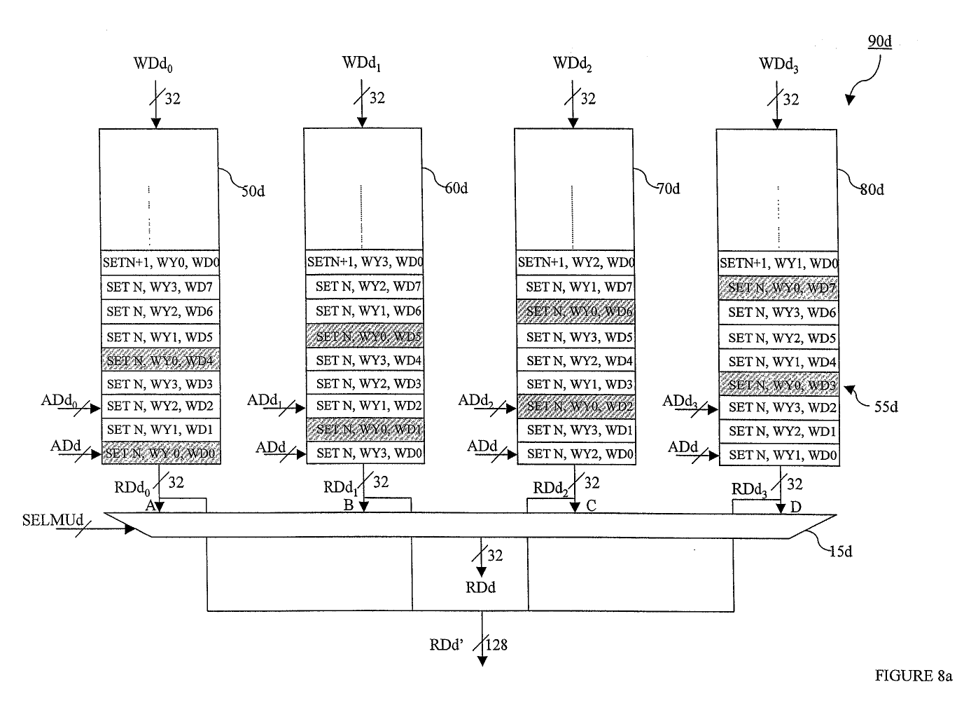

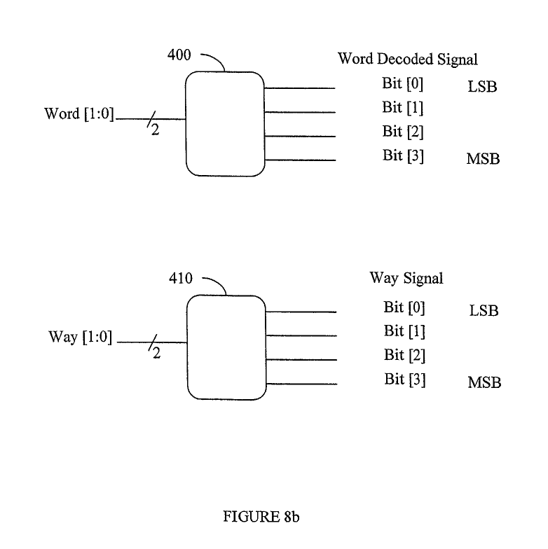

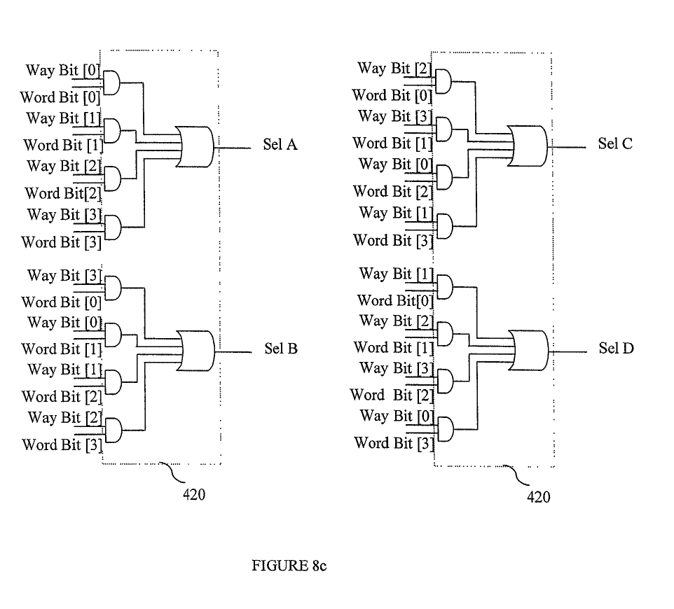

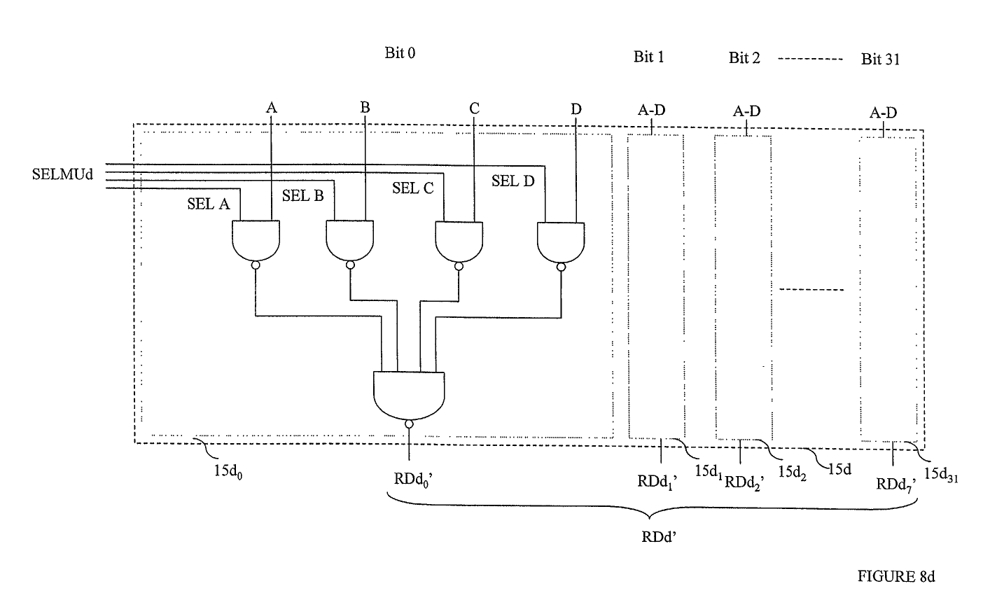

FIG. 8a illustrates a cache arrangement according to an embodiment of the present invention.

In this illustrative arrangement cache 90d includes 4 RAM chips, each RAM chip 50d, 60d, 70d, 80d being operable to store data words from different ways. Hence, each RAM chip is no longer associated with just one or two ways, but is preferably associated with all of the ways, in this example 4 ways. The provision of four write data buses WDd₀₋₃, four read data buses RDd₀₋₃ and the logical arrangement of entries in the RAM chips allows four data words to be accessed in each cycle.

As illustrated in FIG. 8a, RAM chip 50d has a number of entries. Each entry has an address portion associated therewith and is operable to store a data word having the same address portion in that entry. The address portion is formed by the SET portion 20 and the WORD portion 30 of the full address 47.

The address portion associated with each entry in each of the RAM chips is arranged such that for any particular set and way, any sequence of data words forming a cache line is distributed evenly across the RAM chips. By distributing the data words across the RAM chips, the number of data words that can be accessed in a clock cycle is increased. The optimal or maximised distribution of the data words will depend on the number of data words in a cache line and the number of RAM chips in the cache.

As shown in FIG. 8a, adjacent entries within each RAM chip have logically sequential addresses since this simplifies the addressing function required of the cache controller. For any particular set, the addresses cycle through a predetermined sequence. For example, the first entry is word 0, the second entry word 1, then word 2 and so on until, for an 8 word cache line arrangement, word 7 is reached as illustrated in FIG. 8a. However, it will be appreciated that any other sequence of data words could have been used such as words 1, 3, 5, 7, 0, 2, 4, 6 or words 6, 7, 4, 5, 2, 3, 0, 1 etc. Whichever predetermined sequence is used, this sequence of data words is repeated for each set. The set also changes according to another predetermined sequence between each sequence of data words. For example, a first sequence of data words may be associated with set N, a second sequence of data words with set N+1, and so on as illustrated in FIG. 8a. However, it will be appreciated that any other sequence of sets could have been used.

Whatever predetermined sequence of sets and data words is used, this sequence is repeated across each RAM chip. Accordingly, respective entries in each of the RAM chips are associated with the same set and word portions. For example, the first entry in each RAM chip shown in FIG. 8a is associated with set N and word 0.

However, respective entries in each of the memory units are arranged to be associated with a different way. For example, the first entry in RAM chip 50d is associated with way 0, whereas the first entry in RAM chip 60d is associated with way 3, the first entry in RAM chip 70d is associated with way 2 and the first entry in RAM chip 80d is associated with way 0. Also, adjacent entries within each RAM chip are associated with a different way. For example, the first entry in RAM chip 50d is associated with way 0, the second entry is associated with way 1, the third entry is associated with way 2, the fourth entry is associated with way 3, and so on. By associating these entries with different ways it is possible to maximise or optimise the distribution or spread of the data words of a cache line across the memory units.

A 32-bit write data bus WDd₀₋₃ is provided to each RAM chip 50d, 60d, 70d, 80d. Each RAM chip also has a 32-bit read data bus RDd₀₋₃ associated therewith.

The cache controller 210 manipulates the address issued by the processor such that it is compatible with the logical arrangement of the RAM chips as will be discussed below. Each RAM chip is provided with a common address bus ADd which provides the SET portion 20 of the address and the MSB bits of the WORD portion 30 (i.e. all bits except the 2 LSBs), and a supplementary address bus ADd₀₋₃ which provides the remaining 2 LSBs of the WORD portion 30 of the address.

When reading a data word from the cache 90d, each RAM chip 50d, 60d, 70d, 80d receives from the cache controller a first address portion (corresponding to the SET portion 20 and all bits except the 2 LSBs of the WORD portion 30 of the full address 47 issued by the processor 200) over the common address bus ADd. The cache controller 210 determines that a single word access is being requested by the processor 200, and provides the same second address portion (corresponding to the remaining 2 LSBs of the WORD portion 30 of the full address 47 issued by the processor 200) over each supplementary address bus ADd₀₋₃. The two components of the address received by each RAM chip over the common bus ADd and its supplementary address bus ADdo-3 forms the logical address of the entry to be read.

Each RAM chip 50d, 60d, 70d, 80d then outputs the data word stored at the entry specified by the logical address onto its read data bus RDd₀₋₃. The four read data buses RDd₀₋₃ are received by the multiplexer 15d.

The cache controller 210 also determines in which way the data word is stored and outputs a select signal to the multiplexer 15d over the select memory unit bus SELMUd. The multiplexer 15d then outputs the data word from the selected memory unit over the read data bus RDd.

A technique for determining the select signal to be provided to the select memory unit bus SELMUd is described with reference to FIG. 8b.

The second address portion (which comprises the two LSBs of the WORD portion 30) of the data word to be read is provided to a Word decoder 400 within the cache controller 210. The Word decoder 400 then outputs one of four 4-bit “Word decoded” signals. Word decoded signal 0 is represented by “0001”, Word decoded signal 1 is represented by “0010”, Word decoded signal 2 is represented by “0100”, and Word decoded signal 3 is represented by “1000” as shown in Table 1 below.

TABLE 1

| Word | | Word decoded signal | | | |
|---|---|---|---|---|---|
| MSB | LSB | MSB | | | LSB |
| Bit | Bit | Bit | Bit | Bit | Bit |
| [1] | [0] | [3] | [2] | [1] | [0] |
| 0 | 0 | 0 | 0 | 0 | 1 |
| 0 | 1 | 0 | 0 | 1 | 0 |
| 1 | 0 | 0 | 1 | 0 | 0 |
| 1 | 1 | 1 | 0 | 0 | 0 |

The cache controller 210 also determines from the TAG memory 315 in which way the data word to be read is stored. The way is provided as a 2-bit word to a Way decoder 410 within the cache controller 210. The Way decoder 410 then outputs one of four 4-bit Way signals. Way signal 0 is represented by “0001”, Way signal 1 is represented by “0010”, Way signal 2 is represented by “0100”, and Way signal 3 is represented by “1000” as shown in Table 2 below.

TABLE 2

| | Way Signal | | | |
|---|---|---|---|---|
| Way | Bit | Bit | Bit | Bit |
| No. | [3] | [2] | [1] | [0] |
| 0 | 0 | 0 | 0 | 1 |
| 1 | 0 | 0 | 1 | 0 |
| 2 | 0 | 1 | 0 | 0 |
| 3 | 1 | 0 | 0 | 0 |

The Word decoded signal output provided by the Word decoder 400 and the Way signal output provided by the Way decoder 410 is provided to a logic array 420 illustrated in FIG. 8c, also within the cache controller 210.

The logic array 420 comprises four sub-arrays, each comprising four AND gates coupled to an OR gate. Each AND gate receives an input from the Word decoder 400 and an input from the Way decoder 410, and provides its output to the associated OR gate. The output from the OR gate forms part of the select signal for the multiplexer 15d, provided over the select memory unit bus SELMUd.

Each sub-array is arranged to provide a select signal to the multiplexer 15d when one of four conditions are met. For example, an example operation of the sub-array whose OR gate provides a signal over the line Sel A, which forms part of the select memory unit bus SELMUd, will now be described. This sub-array receives at one input of a first AND gate bit 0 from the output of the Way decoder 410 and at the other input bit 0 from output of the Word decoder 400. Should these inputs both provide a logic ‘1’, indicating that the data word to be read is word 0 of way 0, then the AND gate will output a logic ‘1’ to the OR gate. The OR gate will in turn also output a logic ‘1’ on the Sel A line which forms part of the select memory unit bus SELMUd. As will be explained later with reference to FIG. 8d, when the multiplexer 15d receives a logic ‘1’ on the Sel A line, the multiplexer 15d will output all bits of the data word provided by memory unit 50d.

Similarly, an example operation of the sub-array whose OR gate provides a signal over the line Sel C which also forms part of the select memory unit bus SELMUd, will now be described. This sub-array receives, at one input of a fourth AND gate, bit 1 from the output of the Way decoder 410, and at the other input, bit 3 from output of the Word decoder 400. Should these inputs both provide a logic ‘1’, indicating that the data word to be read is word 3 of way 1, then the AND gate will output a logic ‘1’ to the OR gate. The OR gate will, in turn will also output a logic ‘1’ on the Sel C line which forms part of the select memory unit bus SELMUd. As will be explained later with reference to FIG. 8d, when the multiplexer 15d receives a logic ‘1’ on the Sel C line, the multiplexer 15d will output all bits of the data word provided by memory unit 70d. The remaining conditions can be readily determined with reference to FIG. 8c.

Hence, for any particular data word and way to be read, only one line of the select memory unit bus SELMUd will provide a logic ‘1’ which will cause the multiplexer 15d to output the contents provided by just one of the memory units.

The configuration and operation of the multiplexer 15d is described in more detail with reference to FIG. 8d.

The multiplexer 15d receives single bit inputs from each of the RAM chips and the select memory unit bus SELMUd from the cache controller 210.

The multiplexer 15d comprises 32 multiplexing units 15d₀₋₃₁, each of which is associated with and operable to provide one bit of a data word from a selected memory unit. For example, multiplexing unit 15d₀ is operable to provide bit 0 from the selected data word, multiplexing unit 15d₁ is operable to provide bit 1 from the selected data word and so on. Each multiplexing unit receives the bit associated with that multiplexing unit from each of the RAM chips. For example, multiplexing unit 15d₀ receives bit 0 from RAM chip 50d at input A, bit 0 from RAM chip 60d at input B, bit 0 from RAM chip 70d at input C and bit 0 from RAM chip 80d at input D.

The signals provided over the select memory unit bus SELMUd control which RAM chip's bits are output by the each multiplexing unit 15d₀₋₃₁ of the multiplexer 15c. By providing a logic ‘1’ on select line Sel A, all bits from the data word provided by RAM chip 50d are output by the multiplexer 15c. Similarly, by providing a logic ‘1’ on select line Sel D, all bits from the data word provided by RAM chip 80d are output by the multiplexer 15c.

Hence, in view of the above description and with reference to FIG. 8a, to read one data word from the cache 90d requires each of the RAM chips to output, over a respective read data bus RDd₀₋₃, a data word corresponding to the logical address and then selecting the data word from the appropriate way. Given that one logical address 45d can be supplied and one corresponding data word can be output over the read data bus RDd in each accessing cycle, as before, reading one data word takes one cycle.

However, when reading 8 data words (such as cache line 55d) for eviction prior to a linefill, the 128-bit read data bus RDd′ is utilised. Each RAM chip 50c, 60c, 70c, 80c receives from the cache controller 210 the first address portion over the common address bus.ADd. The cache controller 210 determines that a multiple word access is being requested by the processor 200. Accordingly, each supplementary address bus ADd₀₋₃ receives a different second address portion.

To determine the second address portions to be provided to each RAM chip, the cache controller firstly determines in which way the cache line is currently being stored by interrogating the TAG memory 315. Once the way has been determined, the cache controller provides second address portions to each RAM chip such that the appropriate data words are output by each RAM chip.

It will be appreciated that many different techniques could be used to determine the second address portions. However, in one such technique, the way in which the word 0 of the cache line to be read is determined. The cache controller 210 is arranged to know that word 0 is stored in RAM chip 50d for way 0, RAM chip 60d for way 3, RAM chip 70d for way 2 and RAM chip 80d for way 1. Hence, the RAM chip that corresponds to the determined way receives “000” as the second address portion. The cache controller is also arranged to know that the RAM chips are arranged in a virtual loop or series such that RAM chip 50d is followed by RAM chip 60d, then RAM chip 70d, RAM chip 80d and back to RAM chip 50d and so on. Hence, the next RAM chip in the virtual loop or series receives “001”, the next receives “010” and the final RAM chip receives “011”.

The data word corresponding to the logical address received by each RAM chip 50d, 60d, 70d, 80d is output over a respective read data bus RDd₀₋₃. These four data words are combined to form a 128-bit word which is provided over a read data bus RDd′.

Once these data words have been provided, the cache controller 210 then provides “100” to the RAM chip associated with word 0, the next RAM chip in the virtual loop or series receives “101”, the next receives “110” and the final RAM chip receives “111”.

Hence, to read 8 data words requires reading the 8 data words, four at a time, over the read data bus RDd′, and takes 2 cycles.

When writing data words to the cache 90d, each RAM chip 50d, 60d, 70d, 80d receives from the cache controller 210 the first address portion over the common address bus ADd. The cache controller 210 determines that a write is being requested by the processor 200 and determines in which way the data words are to be stored. The cache controller 210 then supplies four data words on the appropriate write data buses WDd₀₋₃ and determines the second address portion to be supplied over each supplementary address bus ADd₀₋₃ in a similar manner to that described above for reading data words.

The address portions received over the common ADd and supplementary address buses ADd₀₋₃ form the logical address associated with the corresponding data words on the write data buses WDd₀₋₃. The RAM chips receive a write enable signal over the common write enable line WEd from the cache controller 210 and store the data words at the specified address.

Hence, to write 8 data words for a linefill requires writing the 8 words, four at a time, over the write data buses WDd₀₋₃, and storing the data words at the entries identified by the corresponding addresses, which also takes 4 cycles.

Advantageously, the arrangement in FIG. 8 maintains the number of RAM chips at 4 whilst halving the access times to two cycles when reading or writing a cache line.

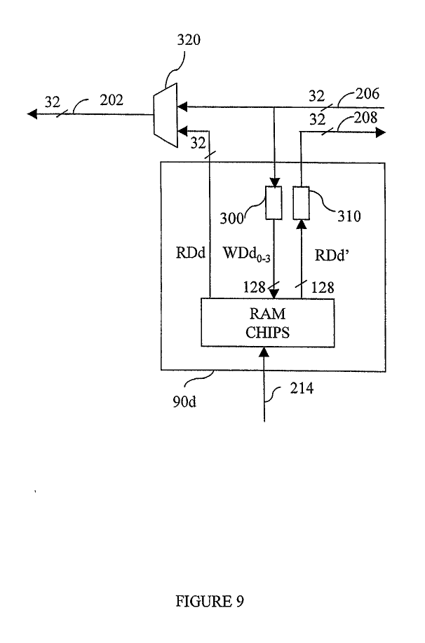

FIG. 9 illustrates an interface buffer arrangement for the cache of FIG. 8. This buffer arrangement is utilised when reading or writing multiple data words for a linefill.

When reading multiple data words from the cache 90d, the four data words are provided over the 128-bit read bus RDd′ to and stored by the read buffer 310 in one clock cycle. The contents of the read buffer 310 can then be emptied in subsequent clock cycles and provided to the memory 230 over external bus 208.

When reading a single word from the cache 90d, the data word is provided over the 32-bit read bus RDd and passed to the processor core 200 via the mutliplexer 320 and the processor data bus 202.

When writing to the cache, the four data words are provided to the write buffer 300 via the data bus 206 over a number of clock cycles. These data words can also be provided simultaneously to the processor core 200 via the mutliplexer 320 and the processor data bus 202. The contents of the write buffer 310 are then written into the cache 90d over the four 32-bit write buses WDd₀₋₃ in one clock cycle.

Although a particular embodiment of the invention has been described herewith, it will be apparent that the invention is not limited thereto, and that many modifications and additions may be made within the scope of the invention. For example, the above description of a preferred embodiment has been described with reference to a unified cache structure. However, the technique could alternatively be applied to the data cache of a Harvard architecture cache, where separate caches are provided for instructions and data. Further, various combinations of the features of the following dependent claims could be made with the features of the independent claims without departing from the scope of the present invention.

I claim:

1. An ‘n’-way set-associative cache, each way comprising a plurality of cache lines, each of said plurality of cache lines comprising a plurality of data words, each of said plurality of data words having associated therewith a unique address, said unique address including an address portion, said ‘n’-way set-associative cache comprising:
a cache memory comprising ‘n’ memory units, each of said ‘n’ memory units having a plurality of entries, respective entries in each of said ‘n’ memory units being associated with the same address portion and being operable to store a data word having that same address portion within its unique address; and
a cache controller operable to determine for a particular way into which of said entries to store the data words of a cache line, each data word being stored at one of said entries within one of the ‘n’ memory units associated with that data word's address portion, each subsequent data word of said cache line being stored in a different memory unit to the previous data word of said cache line so as to maximise the distribution of the data words across the ‘n’ memory units.

2. The ‘n’-way set-associative cache of claim 1, wherein said plurality of entries within each said memory unit comprise logically sequential entries having logically sequential address portions, each logically sequential entry being associated with a different way to its preceding logically sequential entry.

3. The ‘n’-way set-associative cache of claim 1, wherein the number of data words in a cache line is ‘p’, where ‘p’ is a multiple of ‘n’, and said cache controller is operable to evenly distribute said data words across the ‘n’ memory units.

4. The ‘n’-way set-associative cache of claim 1, wherein ‘q’ access ports are provided so that up to ‘q’ data words are accessed per clock cycle.

5. The ‘n’-way set-associative cache of claim 4, wherein ‘q’ equals ‘n’ so that ‘n’ data words are accessed per clock cycle.

6. The ‘n’-way set-associative cache of claim 1, wherein said plurality of data words in each cache line is ‘p’, where ‘p’ is greater than ‘n’, and said cache memory has ‘n’ access ports, each access port being operable to access one data word per cycle such that during an access of a cache line of data words, ‘n’ data words are accessed per clock cycle.

7. The ‘n’-way set-associative cache of claim 6, wherein the ‘n’ access ports are write ports, each write port being operable to write to the cache one data word per cycle such that during the writing of a cache line of data words, ‘n’ data words of the cache line are written per clock cycle.

8. The ‘n’-way set-associative cache of claim 6, wherein the ‘n’ access ports are read ports, each read port being operable to read from the cache one data word per cycle such that during the reading of a cache line of data words, ‘n’ data words of the cache line are read per clock cycle.

9. The ‘n’-way set-associative cache of claim 7, further comprising ‘n’ read ports, each read port being operable to read from the cache one data word per cycle such that during the reading of a cache line of data words, ‘n’ data words of the cache line are read per clock cycle.

10. The ‘n’-way set-associative cache of claim 1, wherein said plurality of data words in each cache line is ‘p’, where ‘p’ is less than or equal to ‘n’, and said cache memory has ‘p’ access ports, each access port being operable to access one data word per cycle such that during an access of a cache line of data words, ‘p’ data words are accessed per clock cycle.

11. The ‘n’-way set-associative cache of claim 10, wherein the ‘p’ access ports are write ports, each write port being operable to write to the cache one data word per cycle such that during the writing of a cache line of data words, said cache line is written in one clock cycle.

12. The ‘n’-way set-associative cache of claim 10, wherein the ‘p’ access ports are read ports, each read port being operable to read from the cache one data word per cycle such that during the reading of a cache line of data words, said cache line is read in one clock cycle.

13. The ‘n’-way set-associative cache of claim 11, further comprising ‘p’ read ports, each read port being operable to read from the cache one data word per cycle such that during the reading of a cache line of data words, said cache line is read in one clock cycle.

14. The ‘n’-way set-associative cache of claim 1, wherein said cache controller is operable to cascade said data words across the ‘n’ memory units.

15. A method of arranging data words in an ‘n’-way set-associative cache, each way comprising a plurality of cache lines, each of said plurality of cache lines comprising a plurality of data words, each of said plurality of data words having associated therewith a unique address, said unique address including an address portion, said ‘n’-way set-associative cache comprising a cache memory comprising ‘n’ memory units, each of said ‘n’ memory units having a plurality of entries, respective entries in each of said ‘n’ memory units being associated with the same address portion and being operable to store a data word having that same address portion within its unique address, said method of arranging data words comprising the steps of:
a) determining a particular way to store the data words of a cache line;
b) storing a data word of said cache line at an entry within one of said ‘n’ memory units associated with that data word's address portion, the entry being associated with said way determined at step (a); and
c) storing each subsequent data word of said cache line in a different memory unit to the previous data word of said cache line so as to maximise the distribution of the data words across the ‘n’ memory units.

16. The method of claim 15, wherein the number of data words in a cache line is ‘p’, where ‘p’ is a multiple of ‘n’, and said step (c) comprises:
storing each subsequent data word of said cache line in a different memory unit to the previous data word of said cache line so as to evenly distribute said data words across the ‘n’ memory units.

17. The method of claim 15, wherein said ‘n’-way set-associative cache has ‘q’ access ports, the method comprising the step of:
(d) accessing up to ‘q’ data words per clock cycle.

18. The method of claim 17, wherein ‘q’ equals ‘n’ and said step (d) comprises:
accessing ‘n’ data words per clock cycle.

19. The method of claim 15, wherein said plurality of data words in each cache line is ‘p’, where ‘p’ is greater than ‘n’, and said ‘n’-way set-associative cache has ‘n’ access ports, and the method further comprises the step of:
d) accessing one data word per cycle such that during an access of a cache line of data words, ‘n’ data words are accessed per clock cycle.

20. The method of claim 19, wherein said ‘n’ access ports are write ports, and said step (d) comprises:
writing to the cache one data word per cycle such that during the writing of a cache line of data words, ‘n’ data words of the cache line are written per clock cycle.

21. The method of claim 19, wherein said ‘n’ access ports are read ports, and said step (d) comprises:
reading from the cache one data word per cycle such that during the reading of a cache line of data words, ‘n’ data words of the cache line are read per clock cycle.

22. The method of claim 20, wherein said ‘n’-way set-associative cache further comprises ‘n’ read ports, said method comprising the step of:
e) reading from the cache one data word per cycle such that during the reading of a cache line of data words, ‘n’ words of the cache line are read per clock cycle.

23. The method of claim 15, wherein said step (c) comprises:
storing each subsequent data word of said cache line in a different memory unit to the previous data word of said cache line by cascading said data words across the ‘n’ memory units.

24. A computer program operable to configure a data processing apparatus to perform a method as claimed in claim 15.

25. A carrier medium comprising a computer program as claimed in claim 24.
